(19) United States
(12) Patent Application Publication
(10) Pub. No.: US 2013/0254020 A1
(43) Pub. Date: Sep. 26, 2013

(54) Systems and Methods for Push Based Advertisement Insertion

(71) Applicants: Niranjan Damera-Venkata, Fremont, CA (US); William J. Allen, Corvallis, OR (US); Mark W. Van Order, Corvallis, OR (US)

(72) Inventors: Niranjan Damera-Venkata, Fremont, CA (US); William J. Allen, Corvallis, OR (US); Mark W. Van Order, Corvallis, OR (US)

(21) Appl. No.: 13/817,701

(22) PCT Filed: Dec. 13, 2010
(86) PCT No.: PCT/US10/60039

§ 371 Date: Feb. 19, 2013

(51) Int. Cl. G06Q 30/02

(52) U.S. Cl. CPC G06Q 30/0247
USPC 705/14.46

(57) ABSTRACT

The present disclosure includes a system and method for push based advertisement insertion. In an example of push based advertisement insertion according to the present disclosure, content (102) to place in a publication is received, a target revenue value for a sale of a number of advertisements in the publication is received; and a layout (116) for the content (102) and for a number of advertisement slots (118) is created, wherein a layout quality is generated based on at least one of a number of templates (460), a number of template parameters (462), and a number of content allocations (464) of the layout, and wherein the layout quality is above a predetermined threshold layout quality based on the target revenue.

### BACKGROUND

Customization of publications has been desirable, but difficult to achieve throughout the history of print media. With the development of word processing and publishing software for use on computers and the ability for computers to print documents, customization of documents has become increasingly more available. Customization based on reader preference is valuable to content publishers and readers because it can allow publishers to get relevant content to readers and it can allow readers to access content that they are most interested in reading. This customization based on reader preference also allows publishers to target advertising to readers and increase the value of the advertisements to the readers and to the advertising entity. Customization of publication can allow publishers to publish content to a variety of mediums. This allows the same content to reach readers in different formats and allow advertisers to advertise in different formats while the same content is published in different formats.

Customization of print media based on the interests of a reader can have a high marginal cost that can make it cost prohibitive due to the manual work required to personalize print media. Customizing print media is desirable because it would allow for customization of advertising to the reader, which allows the publisher to sell advertisements at a higher cost, the advertiser to reach a targeted audience, and the reader to receive information about products that are relevant to the reader. The quality of advertisements in print media can be higher than other types of media, thus making customization of advertising in print media more valuable because of the increase in quality advertisements that are customized to a reader. Creating a system that reduces or eliminates the manual work of customizing print media and the advertisements in the print media can provide an added benefit to the publisher, the advertiser, and the reader.

### BRIEF DESCRIPTION OF THE DRAWINGS

FIG. 1 is a diagram illustrating components of an example of a publication customization system according to the present disclosure.

FIG. 2 is a graph illustrating the relationship between quality and revenue in a publication in an example of a customized publication according of the present disclosure.

FIG. 3 is a template illustrating a content and advertisement layout of a page in an example of a customized publication according to the present disclosure.

FIG. 4 is an example of a Bayesian network illustrating the conditional independencies of templates, template parameters, and content allocations in a Bayesian probability model according to the present disclosure.

FIG. 5 is a method flow diagram illustrating an example of publication customization according to the present disclosure.

### DETAILED DESCRIPTION

The present disclosure includes systems and methods for push based advertisement insertion. An example of a method for advertisement insertion can include receiving content to place in a publication, receiving a target revenue value for a sale of a number of advertisements in the publication, and creating a layout for the content and for a number of advertisement slots, wherein a layout quality is generated based on at least one of a number of templates, a number of template parameters, and a number of content allocations of the layout, and wherein the layout quality is above a predetermined threshold layout quality based on the target revenue.

In some examples, a Bayesian probability model quantifies the quality of the layout the quality and includes random variables associated with a number of templates, a number of template parameters, and a number of content allocations.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice this disclosure, and it is to be understood that other examples may be utilized and that process, electrical, and/or structural changes may be made without departing from the scope of the present disclosure.

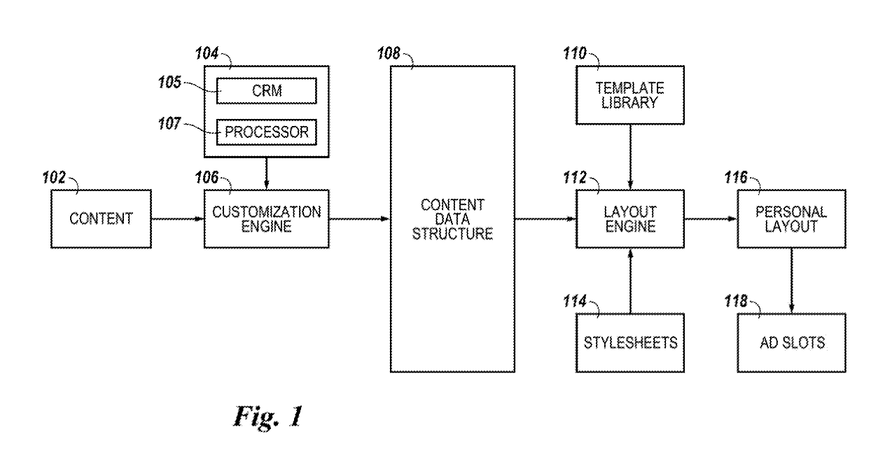

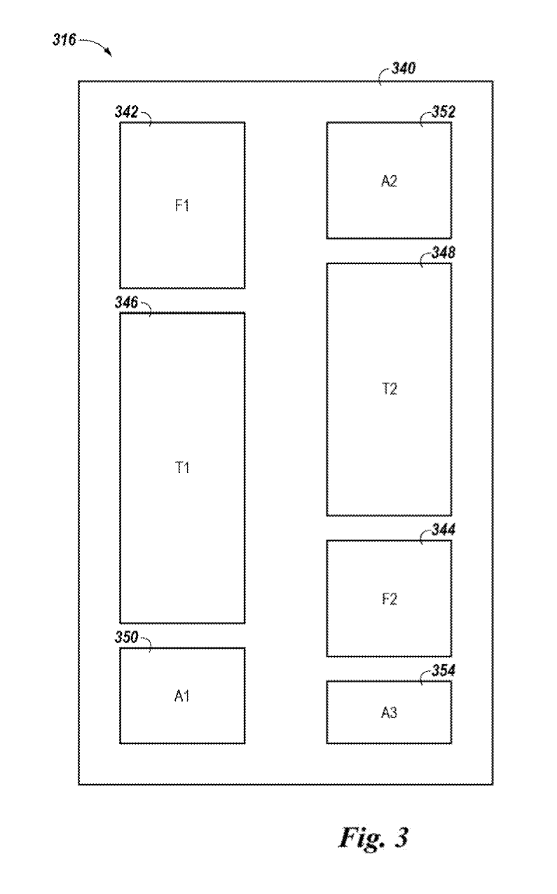

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1, and a similar element may be referenced as 316 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 is a diagram illustrating components of an example of a publication customization system according to the present disclosure. In FIG. 1, a publication customization system can include a content data structure 108. The content data structure 108 can include the text and figures, the relationships between text and figures, and references between text and figures of content 102 in a customized publication. The content 102 for a publication can include a variety of text and figures relating to a variety of topics. The customization engine 106 can use instructions stored on a computer readable medium 105 to select a portion of the content 102 to include in a customized publication that is targeted to an individual or a group of individuals having similar traits. The content 102 selected by the customization engine 106 for a customized publication can have relationships between text and figures, and references between text and figures of the content 102 defined in the content data structure 108.

In FIG. 1, a publication customization system can include a computing device 104 that includes a processor 107 and a non-transitory computer readable medium (CRM) 105 for executing instructions. The components of the publication customization system can include a number of computing devices that include processors and non-transitory computer readable medium (CRM) for executing instructions. That is, the executable instructions can be stored in a fixed tangible medium communicatively coupled to a number of processors. Memory can include random access memory (RAM), read-only memory (ROM), and/or mass storage devices, such as a hard disk drive, tape drive, optical drive, solid state drive, and/or floppy disk drive.

The non-transitory computer readable media can be programmed with instructions such as an operating system for controlling the operation of the publication customization system. The operating system and/or applications may be implemented as a number of executable instructions stored at a number of locations within volatile and/or non-volatile memory.

In push based advertisement insertion, a publisher can provide content. A target revenue, which can be a desired amount of revenue generated by the sale of advertisements in a publication that contains the content, and/or a target layout quality, which can be a desired layout quality associated with a layout that contains the content, can also be provided. The target revenue and/or the target layout quality can be set by a slider. The target revenue can be set by a publisher of the publication or by a consumer that would like to read the publication. The amount of revenue generated by the advertisements can be dependent on advertisement categories, such as the size of the advertisements, and the prices of each advertisement category. The layout quality can be dependent on at least one of a number of templates, a number of template parameters, and a number of content allocations of the layout. A layout can be created with a format for including the content provided by the publisher and advertisement slots that generate the revenue intended by the publisher. A layout can include the layout of the content and the layout of the advertisements. The layout of the advertisements can include advertisement slots that are located through the publication, which can be sold to advertisers by the publisher based on the content and the content layout of the publication. The layout can be customized to maximize the quality of the layout and the revenue generated by the advertisements in the layout.

The publication customization system in FIG. 1 includes a layout engine 112 that can create a personal layout 116 for the customized publication based on the content data structure 108, templates from a template library 110, and stylesheets 114. The personal layout 116 for the customized publication can include advertisement slots 118. The advertisement slots 118 can include locations for placement of advertisements in the customized publication based on the content of the customized publication, the relationship between the text and/or figures of the content, the quality of the advertisement slots, and the revenue generated by the advertisement slots. Stylesheets 114 can define the type of content and the formatting of the content used in making a customized publication and the template library 110 can include a number of templates with layouts for the content used in making a customized publication.

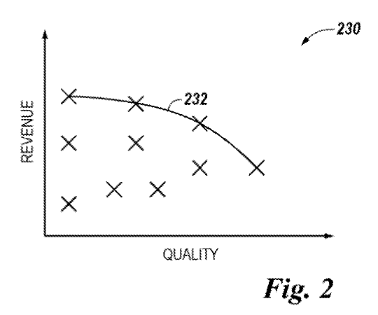

FIG. 2 is a graph 230 illustrating the relationship between quality and revenue in a publication in an example of a customized publication according of the present disclosure. In FIG. 2, each “x” on the graph illustrates a relationship between the layout quality of a publication and the revenue generated by advertisement slots for a customized publication. The revenue generated by advertisement slots can be dependent on size of the advertisement slots and the number of each size of advertisement slots. For example, a larger advertisement slot generates more revenue than a small advertisement slot. The layout quality of the content and the advertisement slots can be dependent on the number of advertisements in a given category, the relevance of the advertisement to the content, and/or the aesthetics of the advertisements in relation to the content layout, among other factors. The layout quality of a publication can be quantified by judging factors such as template layouts, template parameters, and/or content allocations of a publication, among other factors.

The efficient frontier 232 on the graph in FIG. 2 illustrates a layout of a publication that maximize quality for a given revenue and that maximize revenue for a given quality. The publications that form the efficient frontier 232 include content and advertisement slots that are defined by sets of templates, template allocations, and content allocations with the best available quality at a revenue and the best available revenue at a quality. Publications with content layouts and advertisements layouts that are illustrated below and to the left of the efficient frontier 232 are less efficient because there are other content layouts and advertisement layouts that can provide more revenue for the quality of the publication and/or can provide better quality for the revenue generated by the publication. A layout in an example according the present disclosure can include combinations of templates, template parameters, and content allocations that have a layout quality above a predetermined threshold layout quality. The threshold layout quality can be a layout quality that is proximate to the efficient frontier for a given revenue. The predetermined threshold layout quality can be user-determined or adaptively computed.

FIG. 3 is a template illustrating a content and advertisement layout of a page in an example of a customized publication according to the present disclosure. In FIG. 3, template 316 can be used as the layout for a page 340 in a customized publication. Template 316 can include a first figure field (F1) 342, a second figure field (F2) 344, a first text field (T1) 346, a second text field (T2) 348, a first advertisement slot field (A1) 350, a second advertisement slot field (A2) 352, and a third advertisement slot field (A3) 354. Template 316 can include template parameters that define the dimensions of the figure, text, and advertisement slot fields and the white spaces between the figure, text, and advertisement slot fields.

A number of templates can be created by a designer, where the designer creates a number of arrangements for content and advertisement slots to meet the needs of a variety of content and a variety of advertisement slots. A numeric value can be associated with the quality of the template based on the aesthetic desirability of a template's layout. A number of template parameters can be created by a designer, where the template parameters can define the fonts, size of fonts, and/or spacing, among other aspects, of the content and advertisement slots of a template. A numeric value can be associated with the quality of the template parameters based on the aesthetic desirability of the template parameters.

The content allocation that forms the content portion of a layout for a publication can also affect the quality of the publication. The proximal relationship between the various types of content in the layout can affect the quality of the content allocation and the aesthetic desirability of the layout can also affect the quality of content allocation. A numeric value can be associated with the quality of the content allocation based on these factors. The numeric values associated with the quality of the templates, template parameters, and/or content allocations can be used in a Bayesian probability model. The numeric values associated with the quality of the templates, template parameters, and/or content allocations can be the probability assigned to each template, template parameter, and content allocation in the Bayesian probability model. The Bayesian probability model can be used to determine combinations of templates, template parameters, and content allocations that have a layout quality above a predetermined threshold layout quality. The predetermined threshold layout quality can be determined based on a level of desired quality given the factors that affect the layout quality. For example, the predetermined threshold layout quality can be user-determined or adaptively computed.

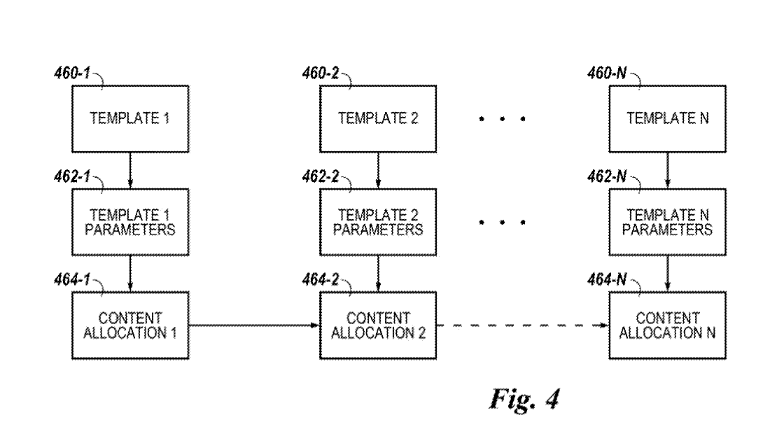

FIG. 4 is an example of a Bayesian network illustrating the conditional independencies of templates, template parameters, and content allocations in a Bayesian probability model according to the present disclosure. Each node of the Bayesian network in FIG. 4 illustrates a random variable corresponding to a page in a sample space. For example, node 460-1 represents random variable Template 1 (T₁) associated with a sample set of templates for a first page of a publication, node 462-1 represents random variable Template Parameters 1 (Θ₁) associated with a sample set of template parameters for a first page of a publication, and node 464-1 represents random variable Content Allocation 1 (C₁) associated with a sample of set of content allocations for a first page of a publication. The arrows between the nodes of the Bayesian network in FIG. 4 illustrate the conditional probabilities between the nodes. For example, the arrow between node 460-1 and 462-1 represents the conditional probability P(Θ₁|T₁) for a set of template parameters Θ₁ given a template T₁. The content allocations 464-1, 464-2, . . . , 464-N have more than one parent node, therefore the conditional probability for node 464-2 is P(C₁|C₀, Θ₁). The Bayesian network defines conditional independency structures, so any node is conditionally independent of its non-descendent given its parent, wherein a non-descendent is a node that does not have an arrow indicating dependence pointing to the node. For template nodes 460-1, 460-2, . . . , 460-N, the probabilities associated with these nodes P(T₁), P(T₂), . . . , P(T_{N}) are not conditioned on any other nodes. For template parameter nodes 462-1, 462-2, . . . , 462-N, the probabilities associated with these nodes P(Θ₁|T₁), P(Θ|T₂), . . . , P(Θ_{N}|T_{N}) are conditioned on the templates.

A joint probability distribution that characterizes the conditional probabilities of a Bayesian network is a product of the probabilities of the parent nodes and the conditional probabilities. Thus the joint probability distribution associated with the Bayesian network in FIG. 4 is:

$$P ( \{ T \} i , \{ Θ i \} \{ Ci \} ) = P ( {C}_{1} \text{\textbar} {Θ}_{1} ) P ( {Θ}_{1} \text{\textbar} {T}_{1} ) P ( {T}_{1} ) … {\prod }_{i = 2}^{N} P ( {C}_{1} \text{\textbar} {Θ}_{i - 1} ) P ( {Θ}_{i} \text{\textbar} {T}_{i} ) P ( {T}_{i} )$$

As shown in FIG. 4, allocation C₁ for the first page “1” is independent, but allocations for each subsequent page depend on the allocation for the previous page. The joint probability distribution associated with the Bayesian network in FIG. 4 is associated with the layout quality of the content and advertisement slots of a publication.

Examples of the present disclosure can include determining pages on a local efficient frontier for quality and revenue based on P({Ti}, {Θi}, {Ci}) for a content layout and advertisement layout. Pages on each local efficient frontier maximize the quality of the content layout and the advertisement layout for the revenue generated by the pages. Also, pages on each local efficient frontier maximize the revenue generated by the page for the quality of the content layout and the advertisement layout of the pages.

In order to find the sets {Tᵢ}, {Θᵢ}, and {Cᵢ}, which include a number of templates, template parameters, and content allocations, respectively, for a publication that gives the probability P({Ti}, {Θi}, {Ci}) on the efficient frontier, the joint probability distribution is defined as follows:

$$\begin{matrix}ψ ( {C}_{i} , {C}_{i - 1} , {T}_{i} ) = {max}_{{Θ}_{i}} P ( {C}_{i} \vert {C}_{i - 1} , {Θ}_{i} ) P ( {Θ}_{i} \vert {T}_{i} ) & Equation ( 1 ) \\ \{ φ ( {C}_{i} , {C}_{i - 1} ) \} = {eff}_{{T}_{1}} \{ ( ψ ( {C}_{i} , {C}_{i - 1} , {T}_{i} ) P ( {T}_{i} ) , R ( {T}_{i} ) ) \} & Equation ( 2 )\end{matrix}$$

Equations (1) and (2) are used to determine content allocations, templates, and template parameters using the method of “belief propagation” from Bayesian methods. For the sake of simplicity, a description of determining set {Cᵢ} of content allocations using belief propagation is described first, followed by a description of determining a template for each content allocation and finally determining template parameters for each template. However, in practice, content allocations, templates, and template parameters can also be determined simultaneously using belief propagation.

The efficient frontier of a set of points, represented in equation (2) by off is a subset of points such that for every point in the subset the subset does not contain any other points with higher revenue and quality. This efficient frontier is represented by the set {φ(Cᵢ,Cᵢ₋₁)} in equation (2). Each {φ(Cᵢ,Cᵢ₋₁)} represents a point on the frontier with two coordinates, revenue and quality. For each point on the frontier of the ith page there is an associated template. Thus the set {φ(Cᵢ,Cᵢ₋₁)} corresponds to a set of templates that may be used for the ith page.

Local frontiers may be combined and propagated in a recursive process as described by the equations below. For example, the frontier for all allocations C₂ to the first two pages can be computed by combining the frontiers for allocations C₁ and allocations C₁ and C₂ respectively.

$$\{ {τ}_{2} ( {C}_{2} ) \} = {eff}_{C 1} \{ φ ( {C}_{1} ) \} \times \{ φ ( {C}_{1} , {C}_{2} ) \}$$

$$\{ {τ}_{N - 1} ( {C}_{N - 1} ) \} = {eff}_{CN - 2} \{ {τ}_{N - 2} ( {C}_{N - 2} ) \} \times \{ φ ( {C}_{N - 1} , {C}_{N - 2} ) \} , \\ and$$

$$\{ {τ}_{N} ( {C}_{N} ) \} = {eff}_{CN - 1} \{ {τ}_{N} ( {C}_{N} ) \} \times \{ φ ( {C}_{N - 1} , {C}_{N} ) \} .$$

The resulting frontier {τ₂(C₂)} can be calculated by first creating a set of points by multiplying the quality of all possible points in {φ(C₁)} with the revenues of all points in {φ(C₁,C₂)} and adding the revenues. This is denoted by the “x” operation in the equations above. The intermediate frontier {τ₂(C₁)} can be computed by taking the efficient frontier of the generated sets over all content allocations C₁. The above equations can be solved until all of the content has been allocated to pages 1 to N and the final efficient frontier {τ₂(C_{N})} is reached. By selecting a point on this frontier that is closest to a revenue target, we can determine a set of content allocations, templates, and template parameters to use for a publication that has an optimal quality at a target revenue. The allocation of the final page N can be used to compute the allocation for page N−1 that caused τ_{N}(C_{N}) to be solved. This process can continue until C₁ is computed. Once the content allocations for each page are found, the content allocations can be used to find the templates for each content allocation by solving ψ(Cᵢ,Cᵢ₋₁,Tᵢ). Once the content allocations and templates for each page are found, the template parameters for each page can be solved. The templates, template parameters, and content allocations for the sets of {Tᵢ}, {Θᵢ}, and {Cᵢ} can be solved similarly.

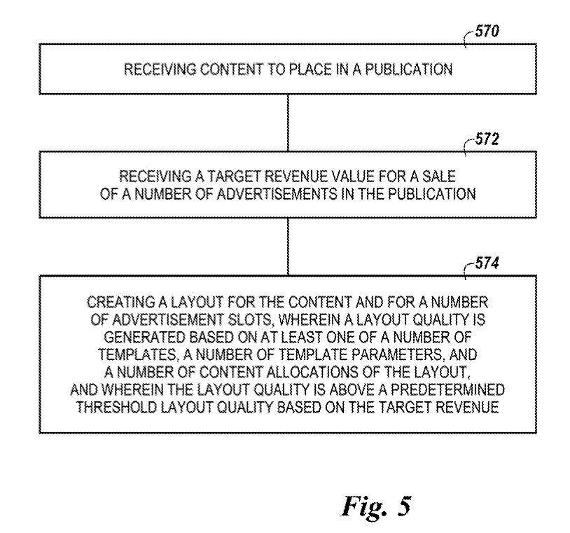

FIG. 5 is a method flow diagram illustrating an example of publication customization according to the present disclosure. A method for advertisement insertion can include receiving content to place in a publication 570, receiving a target revenue value for a sale of a number of advertisements in the publication 572, and creating a layout for the content and for a number of advertisement slots, wherein a layout quality is generated based on at least one of a number of templates, a number of template parameters, and a number of content allocations of the layout, and wherein the layout quality is above a predetermined threshold layout quality based on the target revenue 574.

In some examples, the layout can include a template that indicates locations of fields containing the content and the number of advertisements on the page of the publication, a number of template parameters that define spatial relationships of and between the fields for the content and the number of advertisements, and a content allocation that defines a location of the content within fields on the page.

In some examples, a Bayesian probability model can quantify the quality of the layout the quality and the Bayesian probability model can include random variables associated with at least one of a number of templates, a number of template parameters, and a number of content allocations.

In an example according to the present disclosure, a system for push based advertisement insertion can include a layout engine, wherein the layout engine receives content for a publication and a target revenue value associated with a sale of a number of advertisements in the publication and contemporaneously selects a set of templates, a set of template parameters, and a set of content allocations to create a layout for the publication, wherein the layout has a quality associated with at least one of the set of templates, the set of template parameters, and the set of content allocations that is above a predetermined threshold quality based on the target revenue value.

An example according to the present disclosure can include a non-transitory computer readable medium having instructions stored thereon executable by a processor to create a layout for content and a number of advertisement slots in a publication, wherein a revenue associated with a sale of the advertisement slots in the layout is above a predetermined threshold revenue based on a target layout quality. The predetermined threshold revenue can be user-determined or adaptively computed. In some examples, the layout quality of the content and the number of advertisement slots in a publication is quantified by a Bayesian probability model and the layout quality is dependent on at least one of a number of templates, a number of template allocations, and a number of content allocations in the publication.

Although specific examples have been illustrated and described herein, those of ordinary skill in the art will appreciate that an arrangement calculated to achieve the same results can be substituted for the specific examples shown. This disclosure is intended to cover adaptations or variations of a number of examples of the present disclosure, it is to be understood that the above description has been made in an illustrative fashion, and not a restrictive one. Combination of the above examples, and other examples not specifically described herein will be apparent to those of skill in the art upon reviewing the above description. The scope of the number of examples of the present disclosure includes other applications in which the above structures and methods are used. Therefore, the scope of number of examples of the present disclosure should be determined with reference to the appended claims, along with the full range of equivalents to which such claims are entitled.

Various examples of the system and method for advertisement insertion have been described in detail with reference to the drawings, where like reference numerals represent like parts and assemblies throughout the several views. Reference to various examples does not limit the scope of the system and method for displaying advertisements, which is limited only by the scope of the claims attached hereto. Additionally, any examples set forth in this specification are not intended to be limiting and merely set forth some of the many possible examples for the claimed system and method for scheduling changes.

Throughout the specification and claims, the meanings identified below do not necessarily limit the terms, but merely provide illustrative examples for the terms. The meaning of “a,” “an” and “the” includes plural reference, and the meaning of “in” includes “in” and “on,” The phrase “in an example,” as used herein does not necessarily refer to the same example, although it may.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim. Rather, as the following claims reflect, the claimed subject matter can lie in fewer than all features of a single disclosed example. Thus, the following claims are hereby incorporated into the Detailed Description, with each claim standing on its own as a separate example.

What is claimed:

1. A computer implemented method for push based advertisement insertion, the method comprising:
receiving content (102) to place in a publication;
receiving a target revenue value for a sale of a number of advertisements (250, 252, 254) in the publication (216); and
creating a layout (116) for the content (102) and for a number of advertisement slots (118), wherein a layout quality is generated based on at least one of a number of templates (460), a number of template parameters (462), and a number of content allocations (464) of the layout, and wherein the layout quality is above a predetermined threshold layout quality based on the target revenue.

2. The method of claim 1, wherein the method includes quantifying the layout quality with a Bayesian probability model (460, 462, 464).

3. The method of claim 2, wherein the method includes associating random variables with the number of templates (460), the number of template parameters (462), and the number of content allocations (464) in the Bayesian probability model.

4. The method of claim 3, wherein the method includes solving the Bayesian probability model to determine an efficient frontier for combinations of the number of templates (460), the number of template parameters (462), and the number of content allocations (464).

5. The method of claim 4, wherein solving the Bayesian probability model includes determining combinations of the number of templates (460), the number of template parameters (462), and the number of content allocations (464) on the efficient frontier that have the highest quality for a given revenue and the highest revenue for a given quality.

6. The method of claim 5, wherein creating the layout includes selecting a combination of templates, template parameters, and content avocations that are on the efficient frontier (232) at the target revenue and above the threshold layout quality.

7. A system for push based advertisement insertion, the system comprising:
a layout engine (112), wherein the layout engine (112) is configured to:
receive content (102) for a publication and a target revenue value associated with a sale of a number of advertisements in the publication; and
select a set of templates (460), a set of template parameters (462), and a set of content allocations (464) to create a layout for the publication, wherein the layout has a quality associated with at least one of the set of templates (460), the set of template parameters (462), and the set of content allocations (464) that is above a predetermined threshold quality based on the target revenue value.

8. The system of claim 7, wherein the quality associated with at least one of the set of templates (460), the set of template parameters (462), and the set of content allocations (464) is quantified in a Bayesian probability model.

9. The system of claim 7, wherein the set of templates (460), the set of template parameters (462), and the set of content allocations (464) for the layout are on an efficient frontier of the Bayesian probability model.

10. The system of claim 7, wherein a set of advertisement allocations for the layout are selected based on the relevance of the set of advertisements to the set of content allocations (464).

11. The system of claim 7, wherein the target revenue value (230) is selected by a publisher.

12. The system of claim 7, wherein the target revenue value (230) is selected using a slider to set the target revenue value.

13. A non-transitory computer readable medium (105) having instructions stored thereon executable by a processor (107) to:
create a layout (116) for content (102) and a number of advertisement slots in a publication; and
wherein a revenue associated with a sale of the advertisement slots (118) in the layout (116) is above a predetermined threshold revenue based on a target layout quality.

14. The non-transitory computer readable medium of claim 13, wherein a layout quality is dependent on at least one of a number of templates (460), a number of template allocations (462), and a number of content allocations quantified by a Bayesian probability model.

15. The non-transitory computer readable medium of claim 14, wherein the layout (116) includes a number of templates (460), a number of template allocations (462), and a number of content allocations on an efficient frontier of the Bayesian probability model at the target layout quality.
